(19) United States
(12) Patent Application Publication
(10) Pub. No.: US 2010/0220062 A1
(43) Pub. Date: Sep. 2, 2010

(54) TOUCH SENSITIVE DISPLAY

(76) Inventor: Mika Antila, Pirkkala (FI)

Correspondence Address: Locke Lord Bissell & Liddell LLP;Attn: IP Docketing, Three World Financial Center, New York, NY, 10281-2101, US

(21) Appl. No.: 12/226,549

(22) PCT Filed: Apr. 21, 2006
(86) PCT No.: PCT/IB2006/001531

§ 371 Date: May 12, 2010

(51) Int. Cl. G06F 3/041; G06F 3/048

(52) U.S. Cl. 345/173; 715/702; 715/835

(57) ABSTRACT

A method involving: detecting a type of actuator for actuating an icon displayed on a touch sensitive display; and automatically displaying an arrangement of icons on the touch sensitive display for actuation by the detected actuator, wherein the arrangement of icons is dependent upon the detected actuator type.

### FIELD OF THE INVENTION

Embodiments of the present invention relate to a touch sensitive display. In particular, they relate to the intelligent arrangement of icons for touch actuation on a touch sensitive display.

### DEFINITION

The term touch sensitive display is used in this document to mean a display that enables user input by touching a display area where information is displayed. One type of touch sensitive display may only detect user input if the display is touched. Another type of touch sensitive display may detect user input if the display is touched and also when the display is nearly touched i.e. when an actuator is brought close to but does not touch the display.

### BACKGROUND TO THE INVENTION

There are a number of different technologies that may be used to form touch sensitive displays and some examples are described below.

The 3M MicroTouch ClearTek Capacitive Touch screen applies a small electric current to each of the four corners of an underlying layer of the screen. When an actuator such as a stylus or human digit touches an overlying layer of the screen, it draws an electric current to the point of contact because of increased capacitance. A controller calculates the x, y position of the finger based upon the increased current drawn from each of the four corners.

The 3M MicroTouch Near Field Imaging Projected Capacitive Touch screen has two glass sheets laminated with a transparent coating of metal oxide on one of the inner glass surfaces. An ac signal is applied to a base layer creating an electrostatic field. When an actuator such as a stylus or human digit comes in contact with the screen, the disturbance in the electrostatic field is detected and converted to a position.

The 3M 5-wire resistive touch screen applies an electric current to a flexible top layer of the screen. When the flexible top layer is touched by an actuator it deforms and makes electrical contact with the base layer. An electric current flows from the flexible top layer, through the point of contact and through the base layer to the four corners of the base layer. The position at which the touch occurred is determined from the electric currents detected at the four corners.

WACOM uses electro-magnetic resonance (EMR) in their touch screens. A series of overlapping antenna coils are created in the display. Each antenna coil transmits then receives in quick succession. The EM field created in transmission couples with a tank circuit in an actuator pen and is sent back to the antenna coil where it is received. The process is repeated rapidly for each antenna coil. The respective signals received at the antenna coils are used to position the actuator.

The display area available in a touch sensitive display is typically fixed and, for hand portable devices, of limited size.

It would be desirable to make the most effect use of this resource in a manner that is convenient to a user.

### BRIEF DESCRIPTION OF THE INVENTION

According to one embodiment of the invention there is provided a method comprising: detecting a type of actuator for actuating an icon displayed on a touch sensitive display; and automatically displaying an arrangement of icons on the touch sensitive display for actuation by the detected actuator, wherein the arrangement of icons is dependent upon the detected actuator type.

According to another embodiment there is provided a device comprising: a detector for detecting a type of actuator for actuating an icon displayed on a touch sensitive display; and a display controller for automatically controlling the display of an arrangement of icons on a touch sensitive display for actuation by the detected actuator, wherein the arrangement of icons is dependent upon the detected actuator type.

According to another embodiment there is provided a method comprising: detecting a proximal physical pointer for selecting an active area of a touch sensitive display; and automatically configuring an arrangement of active areas for selection on the touch sensitive display in dependence upon the detection of the proximal pointer.

### BRIEF DESCRIPTION OF THE DRAWINGS

For a better understanding of the present invention reference will now be made by way of example only to the accompanying drawings in which:

FIG. 1 illustrates an electronic device having a touch sensitive display;

FIG. 2 schematically illustrates a method for controlling the arrangement of icons displayed on a touch sensitive display;

FIG. 3A illustrates an arrangement of icons suitable for actuation using a stylus;

FIG. 3B illustrates an arrangement of icons suitable for actuation using a finger; and

FIG. 4 illustrates an apparatus for detecting an actuator.

### DETAILED DESCRIPTION OF EMBODIMENTS OF THE INVENTION

FIG. 1 schematically illustrates an electronic device 16 comprising: a touch sensitive display 2, a processor 8, a memory 10 and a detector 14. For simplicity, only the features and components that are necessary for describing embodiments of the invention are illustrated and described.

The touch sensitive display 2 performs an output display function using display 6 and a user input function using a touch screen 4. The display 6 and touch screen 4 are in register. They may be separate components or integrated into a single component.

The touch screen 4 may use any suitable technology. It may, for example, use one of the technologies described in the background section of this document or an alternative suitable technology.

An actuator 18 is used to actuate the touch screen 4. There are different types of actuators 18 including a pointed stylus that is held in a user's hand and also a digit or finger of a user's hand. An actuator is a physical pointer for pointing at an icon or other active area of a touch screen 4.

The processor 8 is connected to read from and write to the memory 10. It also receives an input from detector 14 and an input from the touch screen 4 and provides an output to the display 6.

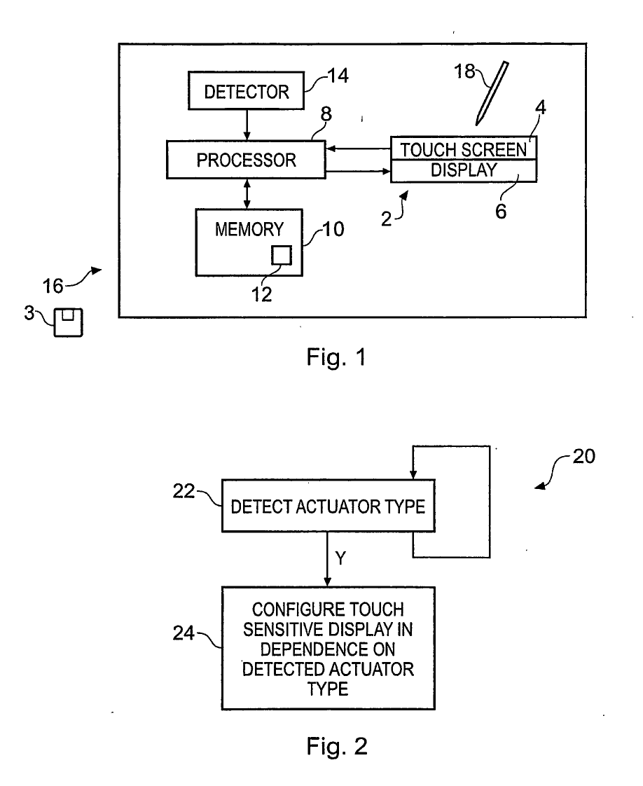

The memory 10 stores computer program instructions 12 that control the operation of the electronic device 16 when loaded into the processor 8. The computer program instructions 12 provide the logic and routines that enables the electronic device to perform the method illustrated in FIG. 2.

The computer program instructions may arrive at the electronic device 16 via an electromagnetic carrier signal or be copied from a physical entity 3 such as a computer program product, a memory device or a record medium such as a CD-ROM or DVD.

The display 6 displays icons 34. An icon 34 may be selected by touching, using the actuator 18, an area of the touch screen 4 that is in register with the displayed icon. An icon is any user selectable symbol. It may be a graphical image, text etc.

The detector 14 is operable to detect the type of actuator 18 being used by a user. Typically, the type of actuator is detected by the detector 14 as the actuator comes close to or touches the touch screen 4.

Information identifying the detected type of actuator is provided by the detector 14 to the processor 8. The processor 8 operates as a display controller and, in response to receiving the information identifying the detected type of actuator, automatically controls the display 6 to provide an arrangement of icons that is dependent upon the detected actuator type on a touch sensitive display 2 for actuation by the detected actuator 18.

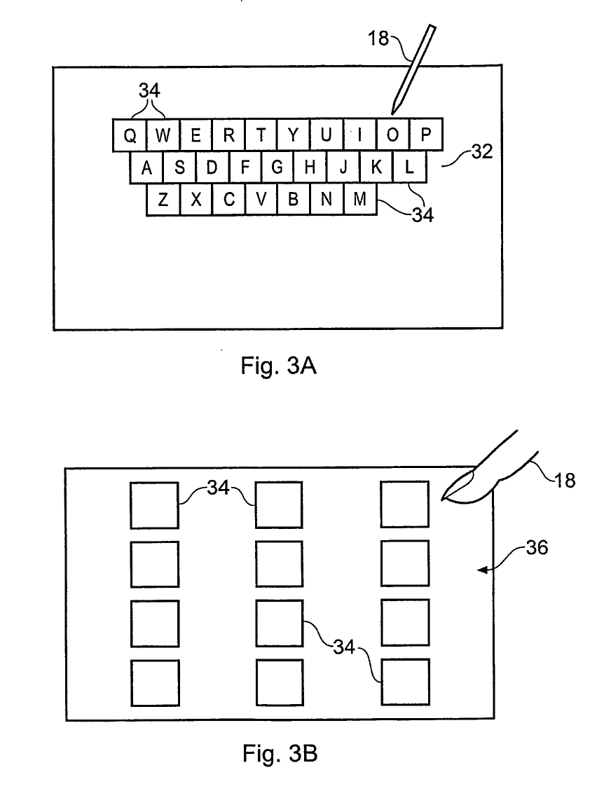

For example, if the detected actuator type is a stylus 18 as illustrated in FIG. 3A, a number of smaller icons 34 may be displayed in a first arrangement 32 of icons. In the illustrated example, 26 icons forming a QWERTY keypad are illustrated. The icons 34 are, in this example, of the same size. If space on the display 6 is limited because, for example, the device 16 is a hand-portable device, the icons may typically have a maximum dimension smaller than 1 cm. The pointed tip of the stylus 18 has an area with a maximum dimension that is significantly smaller than 1 cm. Consequently, the accurate selection of an icon 34 using the stylus is possible.

As another example, if the detected actuator type is a human digit or finger 18 as illustrated in FIG. 3B, a smaller number of larger icons 34 may be displayed in a second arrangement 36 of icons. In the illustrated example, 12 icons form an ITU-T keypad such as that provided on a mobile cellular telephone for text entry. The icons 34 are, in this example, of the same size. If space on the display 6 is limited because, for example, the device 16 is a hand-portable device, the icons may typically have a maximum dimension of at least 1 cm and typically the separation between the centres of adjacent icons will be greater than 1 cm. The point of a finger 18 has an area with a maximum dimension that is of the order 1 cm. Consequently, the accurate selection of an icon 34 using a finger 18 is possible because larger icons are provided.

If the first arrangement 32 of smaller icons is displayed on the touch sensitive display 2, then detection of the use of a finger as the actuator 18 will, in one embodiment, result in an automatic re-configuration of the arrangement of icons 34 to that illustrated in FIG. 3B.

If the arrangement 36 of larger icons is displayed on the touch sensitive display 2,

detection of the use of a stylus as the actuator will, in one embodiment, result in an automatic re-configuration of the arrangement of icons 34 to that illustrated in FIG. 3B.

The detector 14 may, for example, detect the type of actuator 18 as a result of its approach towards the touch sensitive display 2 or as a result of its contact with the touch sensitive display 2. The detector 14 may, in some embodiments, be integrated with the touch screen 4.

Detecting the type of actuator 18 as a result of its approach towards the touch sensitive display 2 may involve the detection, at a distance, of a characteristic of the actuator.

Different actuators may have different characteristics. In this case, each actuator may be separately detected and the detection of a particular type of actuator will result in a particular arrangement of icons 34.

Alternatively, a first type of actuator (e.g. a stylus) may have a detectable characteristic whereas another second type of actuator (e.g., a finger) may not have a detectable characteristic. In this case, only the first type of actuator may be detected. The arrangement of icons may therefore default to an arrangement suitable for the second type of actuator but change to an arrangement more suited to the first type of actuator after detection of the first type of actuator.

In one embodiment, the actuator may comprise an RFID tag or a tank circuit (e.g. as in the WACOM pen) that may be energised by a plurality of separate transceivers arranged in or around the touch sensitive display 2. The time delay in receiving a reply at a transceiver after sending a poll gives an indication of distance from that transceiver. If this is repeated for a plurality of non-collinear transceivers, the position of the actuator 18 may be determined using a triangulation algorithm.

In another embodiment, the actuator may comprise a radioactive element. A solid state radioactivity detector may determine that the actuator has approached within a certain distance when the detected radiation level exceeds a threshold.

In another embodiment, the actuator may comprise a magnetic element. A solid state magnetic field detector may determine that the actuator has approached within a certain distance when the detected H field exceeds a threshold.

In another embodiment, the actuator may comprise a large capacitance. The approach of a large capacitance may be detected in a number of ways. For example, it may couple with the capacitance of an oscillator and cause a detectable shift in its operational frequency. Alternatively it may result in an increasing current flow in a capacitive touch screen 4 as the actuator approaches the touch screen 4.

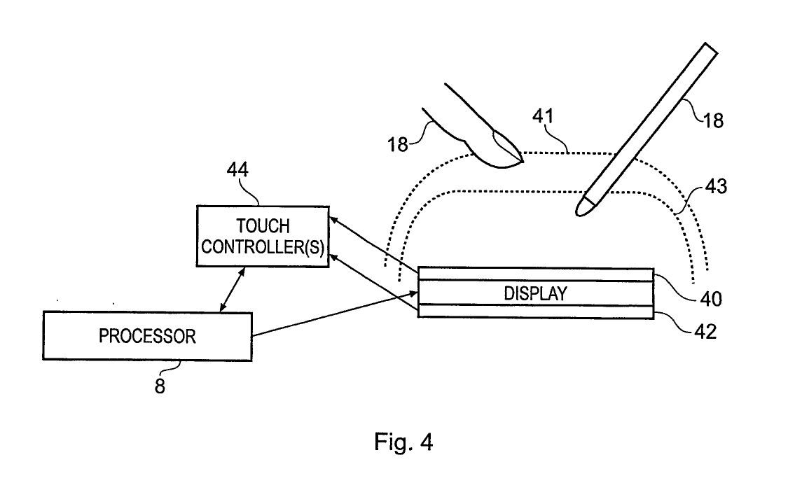

Detecting the type of actuator 18 as a result of its contact with the touch sensitive display 2 may involve the detection, on contact with the touch sensitive display, of the resolution of the actuator. In this example, the detector 14 may conveniently be integrated with the touch screen 4 as illustrated in FIG. 4.

In FIG. 4, the detector 14 comprises a finger touch sensor 40, a stylus touch sensor 42 and a touch controller(s) 44. The finger touch sensor 40 may be, for example, a transparent capacitive sensor with a detection range 41. The stylus touch sensor 42 may be, for example, an EMR sensor with a detection range 43. A sensor converts a physical factor such as proximity or touch to an electrical signal and the touch controller 44 processes the electrical signal by, for example, converting the electrical signal from the analogue domain to the digital domain.

Different actuators may have different characteristic footprints or resolutions. For example, a stylus has a small contact area whereas a finger has a much larger contact area. A minor modification to the algorithms used to calculate the position at which the touch screen 4 is touched by the actuator will result in the algorithm not only returning a position at which the actuator 18 touched the touch screen 4 but also an indication of the error in that value. If the touch screen 4 was touched by a stylus actuator 18 the error will typically be beneath a predetermined threshold whereas if the touch screen 4 was touched by a finger actuator 18 the error will typically be above the predetermined threshold.

The device 16 may enter a power save state in which the display 6 is not active. However, the touch screen 4 may remain active. The device 16 may be woken-up and the display made active by touching the touch screen 4 with an actuator. The device not only ‘wakes-up’ as a result of this touch but also automatically identifies the type of actuator 18 and provides an appropriate configuration 32, 36 of icons 34 for selection.

FIG. 2 schematically illustrates a method 20 for controlling the operation of a touch sensitive display 2.

At step 22, the method 20 detects a type of actuator.

At step 24, the method 20 automatically displays on display 6 an arrangement of icons 34 on the touch sensitive display 2. Each icon 34 identifies a region of the touch screen that may be actuated by the actuator 18 to select the icon 34. The arrangement of icons 34 displayed depends upon the type of actuator 18 detected.

For example, a QWERTY keypad may be displayed if a stylus actuator is detected, otherwise an ITU keypad may be displayed in a finger actuator is detected otherwise a normal keypad menu may be displayed.

Although embodiments of the present invention have been described in the preceding paragraphs with reference to various examples, it should be appreciated that modifications to the examples given can be made without departing from the scope of the invention as claimed. For example, although the device 16 has been described as a programmed processor, it functionality may alternatively be provided by dedicated circuitry such as ASICs if desired.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

I/We claim:

1. A method comprising:
detecting a type of actuator for actuating an icon displayed on a touch sensitive display; and
automatically displaying an arrangement of icons on the touch sensitive display for actuation by the detected actuator, wherein the arrangement of icons is dependent upon the detected actuator type.

2. A method as claimed in claim 1, further comprising:
automatically changing an arrangement of icons on a touch screen display from a second arrangement of icons to a first arrangement of icons in response to the detection of a first type of actuator.

3. A method as claimed in claim 2, wherein the first arrangement of icons comprises a first plurality of icons for actuation by a first actuator type and the second arrangement of icons comprises a second plurality of icons for actuation by a second actuator type.

4. A method as claimed in claim 3, wherein the first actuator type is a stylus.

5. A method as claimed in claim 3, wherein the first plurality of icons is greater than the second plurality of icons.

6. A method as claimed in claim 3, wherein the first plurality of icons have an average first size and the second plurality of icons have an average second size and the average first size is less than average second size.

7. A method as claimed in claim 3, wherein the first arrangement of icons provides a QWERTY keypad.

8. A method as claimed in claim 3, wherein second actuator type is a human digit.

9. A method as claimed in claim 8, wherein second plurality of icons is greater than first plurality of icons.

10. A method as claimed in claim 8, wherein the first plurality of icons have an average first size and the second plurality of icons have an average second size and the average second size is greater than average first size.

11. A method as claimed in claim 8, wherein adjacent ones of the second plurality of icons have centers separated by at least 1 cm.

12. A method as claimed in claim 8, wherein the second arrangement of icons provides an ITU-T keypad.

13. A method as claimed in claim 1, wherein detecting the type of actuator involves the detection, at a distance, of a characteristic of the actuator.

14. A method as claimed in claim 1, wherein detecting the type of actuator involves the detection, on contact with the touch sensitive display, of the resolution of the actuator.

15. A device comprising:
a detector configured to detect a type of actuator for actuating an icon displayed on a touch sensitive display; and
a display controller configured to automatically control a display of an arrangement of icons on a touch sensitive display for actuation by an actuator, wherein the arrangement of icons is dependent upon the detected type of actuator.

16. A device as claimed in claim 15 wherein the detector detects, at a distance, a characteristic of the actuator.

17. A device as claimed in claim 15 wherein the detector detects, on contact with the touch sensitive display, a resolution of the actuator.

18. A device as claimed in claim 17 wherein the detector is integrated with the touch sensitive display.

19. A device as claimed in claim 15, sized for hand portability.

20. (canceled)

21. A method comprising:
detecting a proximal physical pointer for selecting an active area of a touch sensitive display; and
automatically configuring an arrangement of active areas for selection on the touch sensitive display in dependence upon the detection of the proximal pointer.

22. A device, comprising:
a display controller configured to automatically control a display of an arrangement of icons on a touch sensitive display for actuation by an actuator, wherein the arrangement of icons is dependent upon a detected type of actuator.

23. A device as claimed in claim 22, wherein the display controller is configured to automatically change an arrangement of icons on a touch screen display from a second arrangement of icons to a first arrangement of icons in response to a detection of a first type of actuator.

24. A device as claimed in claim 23, wherein the first arrangement of icons comprises a first plurality of icons arranged for actuation by a stylus actuator type and the second arrangement of icons comprises a second plurality of icons arranged for actuation by a human digit actuator type.

25. An article of manufacture comprising a computer readable medium containing computer processor readable code, which when executed by a processor causes the processor to perform: automatically controlling an arrangement of icons on a touch sensitive display for actuation by an actuator, wherein the arrangement of icons is dependent upon a detected type of actuator.

26. An article of manufacture as claimed in claim 25, wherein the code, when executed, causes the processor to automatically change an arrangement of icons on a touch screen display from a second arrangement of icons to a first arrangement of icons in response to a detection of a first type of actuator.

27. An article of manufacture as claimed in claim 26, wherein the first arrangement of icons comprises a first plurality of icons arranged for actuation by a stylus actuator type and the second arrangement of icons comprises a second plurality of icons arranged for actuation by a human digit actuator type.

28. A device, comprising:
means for detecting a type of actuator for actuating an icon displayed on a touch sensitive display; and
means for automatically controlling a display of an arrangement of icons on a touch sensitive display for actuation by an actuator, wherein the arrangement of icons is dependent upon the detected type of actuator.
